(19) United States
(12) Patent Application Publication
(10) Pub. No.: US 2025/0248418 A1
(43) Pub. Date: Aug. 7, 2025

(54) METHOD OF PREPARING MARSHMALLOW ICE CREAM

(71) Applicant: RORO F&B Corporation, Wonju-si (KR)

(72) Inventor: Jae Myeon CHA, Yeoju-si (KR)

(73) Assignee: RORO F&B Corporation, Wonju-si (KR)

(21) Appl. No.: 18/980,386

(22) Filed: Dec. 13, 2024

(30) Foreign Application Priority Data
Feb. 1, 2024 (KR) 10-2024-0016183

(51) Int. Cl. A23G 9/48; A23G 9/08; A23G 9/42

(52) U.S. Cl. CPC A23G 9/48; A23G 9/083; A23G 9/42

(57) ABSTRACT

Disclosed is a method of preparing a marshmallow ice cream. The method has an effect of improving consumer satisfaction by allowing a cool marshmallow to be consumed in combination with ice cream. The method comprises step of preparing dough ingredients with soaking a gelatin powder and a resin, as ingredients of marshmallow in water (ST 1); step of dough whipping with putting the soaked dough ingredients and syrup into a kneader and performing whipping for 5 to 10 minutes (ST 2); step of filling a portion mold having a predetermined shape with the marshmallow dough (ST 3); step of mounting an ice cream prepared in a hexahedral shape on the marshmallow dough filling the portion mold (ST 4); and step of further supplying the marshmallow dough to prevent exposure of the mounted ice cream (ST 5).

### CROSS-REFERENCE TO THE RELATED APPLICATION

The present application claims priority to and the benefit of Korean Patent Application No. 10-2024-0016183, filed on Feb. 1, 2024, in the Korean Intellectual Property Office, the entire disclosure of which is incorporated herein by reference.

### BACKGROUND

### 1. Field

Embodiments of the present disclosure relate to a method of preparing marshmallow ice cream to consume marshmallow in combination with ice cream.

### 2. Description of the Related Art

Marshmallow, which applied is to various confectioneries such as pies, is generally prepared by adding animal protein such as gelatin and egg albumin as main ingredients, adding sugar and a foaming agent thereto, and then adding water to the solution to encapsulate air (bubbles).

Meanwhile, a recipe for preparing marshmallows in the form of ice cream has recently been proposed to consume cool marshmallows in the summer.

That is, the process of preparing marshmallow ice cream includes mixing marshmallow with milk, melting the resulting mixture in a microwave, and then freezing the result in a freezer so that the marshmallow can be consumed in the form of ice cream.

However, the marshmallow ice cream in the prior art simply forms a frozen marshmallow, and thus immediately melts away at room temperature, making it inconvenient to eat.

### PRIOR ART LITERATURE

### Patent Literature

(Patent literature) Korean Patent Publication No. 2006-0119348 (published on Nov. 24, 2006)
(Patent literature) Korean Patent Publication No. 2011-0093742 (published on Aug. 18, 2011)
(Patent literature) Korean Patent Publication No. 2014-0008359 (published on Jan. 21, 2014)
(Patent literature) Korean Patent Publication No. 2017-0034052 (published on Mar. 28, 2017)

### SUMMARY

Embodiments of the present disclosure provide a recipe for preparing marshmallow ice cream capable of forming a structure in which marshmallow is surrounded by ice cream to prevent the ice cream from melting and to allow cool marshmallows to be consumed even in the summer.

A method of preparing a marshmallow ice cream according to an embodiment of the present disclosure to accomplish the above object comprises, step of preparing dough ingredients with soaking a gelatin powder and a resin, as ingredients of marshmallow in water (ST 1); step of dough whipping with putting the soaked dough ingredients and syrup into a kneader and performing whipping for 5 to 10 minutes (ST 2); step of filling a portion mold having a predetermined shape with the marshmallow dough (ST 3); step of mounting an ice cream prepared in a hexahedral shape on the marshmallow dough filling the portion mold (ST 4); and step of further supplying the marshmallow dough to prevent exposure of the mounted ice cream (ST 5).

In one embodiment of the present disclosure, in the step of preparing dough ingredients (ST 1), the resin is characterized to be prepared from one optionally selected from a chocolate resin, a strawberry resin, a lemon resin, or a banana resin.

In one embodiment of the present disclosure, the ice cream used in the step of mounting an ice cream (ST 4) is characterized to have a hexahedral shape smaller than the portion mold, and a surface coating layer is formed as a thin film on the surface of the ice cream to improve shape retention.

In one embodiment of the present disclosure, the surface coating layer is characterized to comprise a mixture of liquid gelatin, honeydew honey, sodium bicarbonate, triacetin, sodium cocoyl glutamate, MCT oil, polyphenol, prolinase, chitosan, wheat bran, and methyl parahydroxybenzoate.

In one embodiment of the present disclosure, the method is characterized to further include vacuum-refrigerating the ice cream to prevent discoloration of the surface coating layer and irradiating the coating layer with near-infrared light having a wavelength of 1.7 to 2.0 μm.

In one embodiment of the present disclosure, in the step of filling the portion mold (ST 3), the portion mold is characterized to be filled with the marshmallow dough after a rice bran oil with tricalcium phosphate added thereto is applied to the surface of the portion mold.

The method of preparing marshmallow ice cream according to the present disclosure has an effect of improving consumer satisfaction by allowing cool marshmallow to be consumed in combination with the ice cream.

In particular, the method has an advantage of providing a cool and diverse texture by allowing baked marshmallows to be consumed in combination with ice cream.

### BRIEF DESCRIPTION OF THE DRAWINGS

FIG. 1 is a flowchart illustrating a process of preparing a marshmallow ice cream according to one embodiment of the present disclosure.

FIG. 2 is an image showing dough whipping according to one embodiment of the present disclosure.

FIG. 3 is an image showing filling of a portion mold according to one embodiment of the present disclosure.

FIG. 4 is an image showing mounting of ice cream in the portion mold according to one embodiment of the present disclosure.

FIG. 5 is an image showing a packaged finished product according to one embodiment of the present disclosure.

FIG. 6 is an image showing a sectional surface of the product obtained according to the recipe of the present disclosure.

FIG. 7 is a flowchart illustrating a process of preparing ice cream according to another embodiment of the present disclosure.

FIG. 8 is a detailed cross-sectional view illustrating ice cream according to another embodiment of the present disclosure.

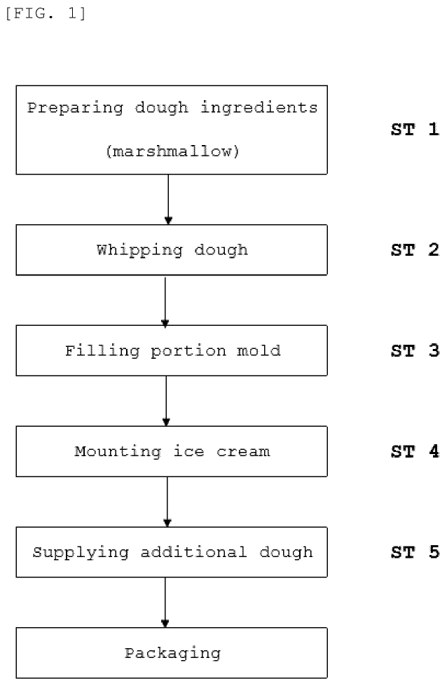

### EXPLANATION OF LETTERS OR NUMERALS

10: Ice cream, 20: Surface coating layer

### DETAILED DESCRIPTION OF EXEMPLARY EMBODIMENTS

Hereinafter, specific embodiments of the present disclosure will be described in detail with reference to the attached drawings.

The embodiments of the present disclosure may be modified in various forms and the scope of the present disclosure should not be construed as being limited to the embodiments described in detail below. These embodiments are provided to more completely explain the present disclosure to a person having ordinary knowledge in the art.

First, the process of preparing a chocolate-flavored marshmallow ice cream according to one embodiment of the present disclosure will be described with reference to FIG. 6 below.

### <Preparation Step of Dough Ingredients> (ST 1)

In the step of preparing dough ingredients, a gelatin powder and a chocolate resin, as ingredients of marshmallow, are soaked in water.

That is, at this time, 390 g of the gelatin powder and 50 g of the chocolate resin are added to 2, 610 g of water, are thoroughly mixed, and are allowed to soak for 1 to 2 hours.

### <Step of Dough Whipping> (ST 2)

Then, the soaked dough ingredients are added into a kneader with syrup and are whipped for 5 to 10 minutes.

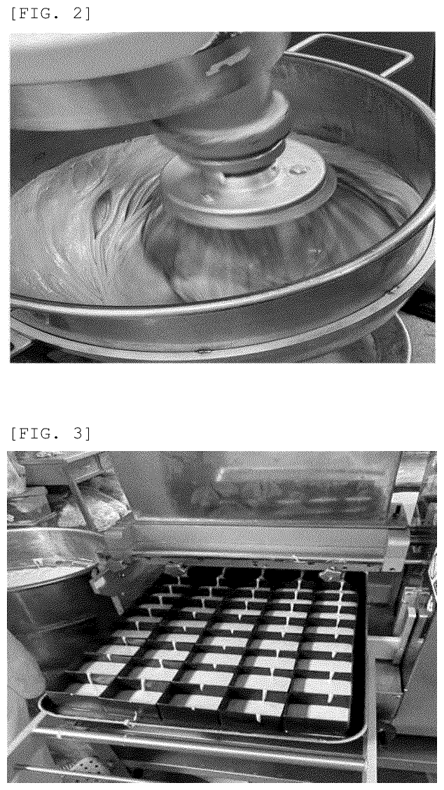

The syrup added herein is prepared by mixing 1, 500 g of a starch syrup, 2,250 g of sugar, and 330 g of water, followed by boiling to 115° C. or higher. Through a dough whipping process as shown in FIG. 2, after putting the dough into the kneader, the dough is whipped until the dough expands and becomes viscous.

### <Step of Filling Portion Mold> (ST 3)

Then, the whipped marshmallow dough is poured into a portion mold having a predetermined shape.

That is, at this time, the marshmallow dough is poured and charged into a portion mold having a plurality of grids as shown in FIG. 3.

Particularly, it is preferable to apply an oil to the portion mold so that the marshmallows can be easily separated therefrom later.

### <Step of Mounting Ice Cream> (ST 4)

The ice cream prepared in a hexahedral shape is mounted on the marshmallow dough charged in the portion mold.

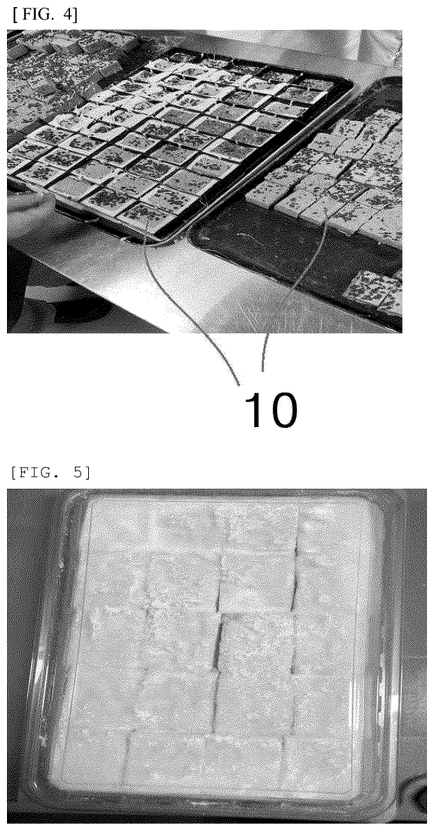

The ice cream used herein is prior prepared to have a smaller size than that of the portion mold and the ice cream cut into a hexahedral shape is mounted as shown in FIG. 4.

Also, at this time, the mounted ice cream is not deliberately pressed, but is mounted in the center and then simply leveled. As a result, the ice cream slowly falls down the dough due to gravity of the ice cream.

### <Step of Supplying Additional Dough> (ST 5)

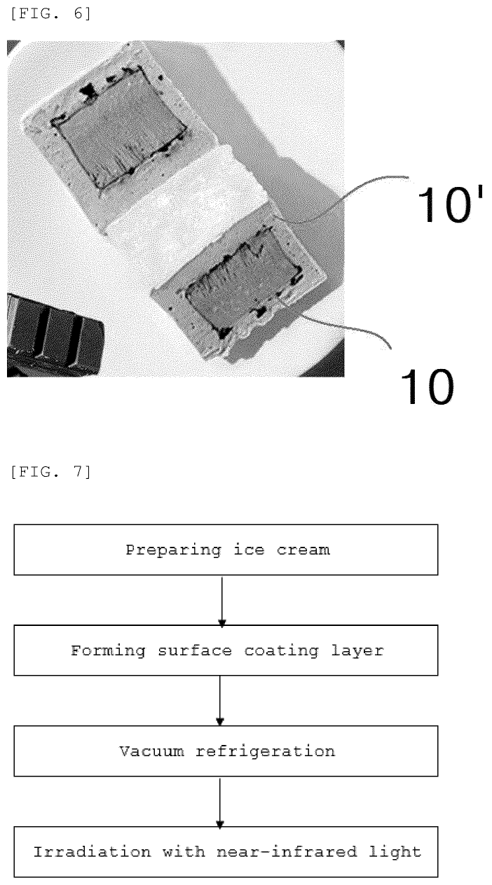

Then, a marshmallow dough is further (additionally) supplied to prevent the exposure of the surface of the mounted ice cream. The product of the present disclosure obtained through this process is completed through packaging as shown in FIG. 5.

The marshmallow ice cream of the present disclosure prepared through the recipe process may be consumed in various forms and ways. Particularly, when the marshmallow constituting the outer surface is lightly baked using heat, the original taste of the marshmallow may be felt along with the inherent taste of the ice cream.

FIG. 6 illustrates a sectional surface of the chocolate-flavored marshmallow ice cream prepared according to an embodiment of the present disclosure, and it can be seen from FIG. 6 that an ice cream 10 is provided in a square shape inside a marshmallow 10′.

Therefore, the method of preparing marshmallow ice cream according to the present disclosure has an effect of improving consumer satisfaction by allowing cool marshmallow to be consumed in combination with the ice cream.

Particularly, the method has an advantage of providing a cool and diverse texture by allowing baked marshmallows to be consumed in combination with ice cream.

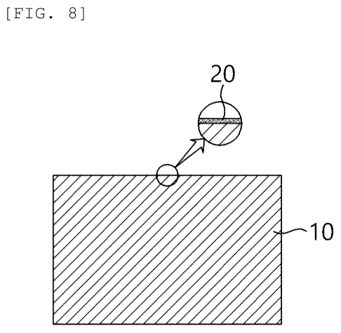

Meanwhile, FIG. 7 and FIG. 8 illustrate a process of preparing a marshmallow ice cream according to another embodiment of the present disclosure. The ice cream 10 used in the step of mounting ice cream (ST 4) is formed into a hexahedral shape during the preparation process and then a surface coating layer 20 is spray-coated as a thin film on the surface of ice cream to improve a shape-retention function.

At this time, the surface coating layer 20 is preferably formed by a mixture of 20 to 40 wt % of liquid gelatin, 5 to 20 wt % of honeydew honey, 1 to 10 wt % of sodium bicarbonate, 1 to 10 wt % of triacetin, 5 to 20 wt % of sodium cocoyl glutamate, 10 to 20 wt % of MCT oil, 5 to 10 wt % of polyphenol, 1 to 10 wt % of prolinase, 1 to 5 wt % of chitosan, 1 to 5 wt % of wheat bran, and 1 to 5 wt % of methyl parahydroxybenzoate.

In addition, the ice cream 10 of the present disclosure is further vacuum-refrigerated to prevent discoloration of the surface coating layer 20 coated on the surface and the coating layer is irradiated with near-infrared light having a wavelength of 1.7 to 2.0 μm.

Meanwhile, in the step of filling the portion mold (ST 3), the portion mold is filled with marshmallow dough after a rice bran oil with tricalcium phosphate added thereto to prevent aggregation in the portion mold is applied to the surface of the portion mold. At this time, the rice bran oil and tricalcium phosphate are preferably mixed in a ratio of 8:2.

When the marshmallow ice cream is prepared in this manner, due to the formation of the surface coating layer 20 shape deformation and deterioration upon contact with the outside air are prevented.

In particular, the surface coating layer 20 is mixed with liquid gelatin and honeydew honey, thus maintaining stable viscosity. Sodium bicarbonate and triacetin prevent deterioration and discoloration of the ice cream 10, and sodium cocoyl glutamate maintains coating stability through the catalytic function of MCT oil. In addition, the polyphenol that is further added allows the coating layer to maintain an overall uniform thickness, prolinase and wheat bran prevent bubbles from forming in the contact area with the ice cream 10, and methyl parahydroxybenzoate serves as a flavoring agent.

In addition, after formation of the surface coating layer 20, vacuum refrigeration prevents occurrence of discoloration of the coating and the irradiation with near-infrared light having a wavelength of 1.7 to 2.0 μm provides effects of providing fixation of the coating layer, flattening of the surface, and providing an antibacterial effect. As such, the ice cream 10 provided with the surface coating layer 20 is mounted in a marshmallow portion mold in the subsequent process.

Therefore, when the step of forming the surface coating layer 20 is performed in the ice cream preparation process, it is possible to obtain an effect of the coating layer serving as an insulator to prevent the ice cream 10 from melting due to during heating of marshmallow to consume the marshmallow ice cream product.

In addition, the rice bran oil with tricalcium phosphate added is applied to the portion mold, thereby facilitating the separation of the marshmallow, which is a gelatinous material, and preventing the phenomenon of sticking.

In addition, although specific embodiments of the present disclosure have been described and illustrated the above, it is obvious that the method of preparing the marshmallow ice cream according to the present disclosure can be modified and implemented by those skilled in the art.

For example, in the embodiment described the above, the addition of the chocolate resin to prepare chocolate-flavored marshmallow ice cream has been described. However, various resins with tastes and flavors such as strawberry resins may be also used, if necessary.

In addition, the heating temperature, ingredient mixing ratio, preheating time, and the like during the preparation process may vary depending on the size and type of the cookie.

Therefore, such modified embodiments should not be understood independently from the technical idea or scope of the present disclosure and such modified embodiments should fall within the scope of the attached claims of the present disclosure.

As is apparent from the above description, the method of preparing a marshmallow ice cream according to the present disclosure has an effect of improving consumer satisfaction by allowing cool marshmallow to be consumed in combination with the ice cream.

In particular, the method has an advantage of providing a cool and diverse texture by allowing baked marshmallows to be consumed in combination with ice cream.

What is claimed is:

1. A method of preparing a chocolate-flavored marshmallow ice cream comprising:
step of preparing dough ingredients with soaking a gelatin powder and a resin, as ingredients of marshmallow in water (ST 1);
step of dough whipping with putting the soaked dough ingredients and syrup into a kneader and performing whipping for 5 to 10 minutes (ST 2);
step of filling a portion mold having a predetermined shape with the marshmallow dough (ST 3);
step of mounting an ice cream prepared in a hexahedral shape on the marshmallow dough filling the portion mold (ST 4); and
step of further supplying the marshmallow dough to prevent exposure of the mounted ice cream (ST 5).

2. The method according to claim 1, wherein, in the step of preparing dough ingredients (ST 1), the resin is prepared from one optionally selected from a chocolate resin, a strawberry resin, a lemon resin, or a banana resin.

3. The method according to claim 1, wherein the ice cream used in the step of mounting the ice cream (ST 4) has a hexahedral shape smaller than the portion mold, and a surface coating layer is formed as a thin film on the surface of the ice cream to improve shape retention.

4. The method according to claim 3, wherein the surface coating layer comprises a mixture of liquid gelatin, honeydew honey, sodium bicarbonate, triacetin, sodium cocoyl glutamate, MCT oil, polyphenol, prolinase, chitosan, wheat bran, and methyl parahydroxybenzoate.

5. The method according to claim 4, further comprising vacuum-refrigerating the ice cream to prevent discoloration of the surface coating layer and irradiating the coating layer with near-infrared light having a wavelength of 1.7 to 2.0 μm.

6. The method according to claim 1, wherein, in the step of filling the portion mold (ST 3), the portion mold is filled with the marshmallow dough after a rice bran oil with tricalcium phosphate added thereto is applied to the surface of the portion mold.
